(19) United States
(12) Patent Application Publication
(10) Pub. No.: US 2014/0101058 A1
(43) Pub. Date: Apr. 10, 2014

(54) SYSTEM AND METHOD FOR PROVIDING CONSUMER SIDE MAINTENANCE

(71) Applicants: MARC CASTEL, Orangeville (CA); Corbin Church, Westmount (CA)

(72) Inventors: MARC CASTEL, Orangeville (CA); Corbin Church, Westmount (CA)

(21) Appl. No.: 14/048,799

(22) Filed: Oct. 8, 2013

Related U.S. Application Data
(60) Provisional application No. 61/711,180, filed on Oct. 8, 2012.

(51) Int. Cl. G06Q 10/00

(52) U.S. Cl. CPC G06Q 10/20
USPC 705/305

(57) ABSTRACT

A computer system is provided that is connected to the Internet and enables a plurality of network connected devices to access a novel and innovative resource management platform. The computer system includes an Internet enabled computer platform that implements a multi-tenant architecture that enables multiple platform clients to populate the platform with various information regarding their maintenance service requirements. The computer system includes one or more tools that (i) track activities of consumers in connection with their appliances or other consumer resource, (ii) extracts insights from such activities, and/or (iii) enables service businesses or manufacturers to upload information or documents related to maintenance services, such tools enabling the automated suggestion of maintenance actions and/or product or service requirements of consumers. A range of different intelligent features are provided. The computer system may include a CMMS with intelligent features. A number of related computer implemented methods for managing maintenance in an intelligent way is also provided.

### FIELD

Embodiments described herein relate to maintenance management systems, and in particular, embodiments described relate to maintenance management systems for providing consumer side maintenance.

### INTRODUCTION

Households and businesses often have numerous appliances or machines. These may include for example refrigerators, washing machines, furnaces, stoves, vacuum cleaners, air conditioners, humidifiers, stereo systems, snow blowers, and so on, whether they are used indoor or outdoor, and regardless of their function (in this disclosure, “appliance” has this broad meaning). “Appliance” may also refer to various business machines as well. These appliances generally have multiple parts, and with use and time can break down or their performance drops.

One problem is that many of these appliances may require maintenance from time to time. This may include for example the replacement of a part, fixing or manipulation of a component, or using the appliance or part thereof in a particular way that nonetheless has a positive effect on the appliance's life cycle (“maintenance actions”).

From a consumer perspective, even keeping track of these various appliances, their manuals, the contact information for services providers, possibly a maintenance schedule, requires significant time that busy households rarely have.

Appliances, and the servicing of appliances, represent a significant industry. Some manufacturers manage their own service programs. In other cases, a company providing maintenance services may partner with a manufacturer. In this disclosure, businesses engaged in providing maintenance services are referred to as a “service business” whether they are for example a manufacturer providing these services, or aspects of these services, or an independent organization. Service businesses may have relationships with one or more manufacturers. In some cases, service businesses may service only particular appliances of a manufacturer, instead of for example an entire product line. The relationships between manufacturers and service businesses vary. Service businesses may be corporate affiliates of manufacturers. Or they may be licensees with the right to use certain trade-marks of the manufacturer, or to access parts or other supplied from the manufacturer, documentation, training and the like.

Various financial arrangements may also exist between manufacturers and service businesses. In contrast, in many cases no relationship exists whatsoever between a service business and a manufacturer.

Service businesses and manufacturers alike are interested in ensuring that appliance servicing is conducted in an efficient and effective manner. However, there are numerous obstacles to this.

Many consumers do not adhere to a suggested maintenance schedule. Yet adhering to a particular maintenance schedule is often critical to ensuring that appliances operate, or continue to operate, based on normal performance parameters. A maintenance schedule may involve particular maintenance actions that optimally may be required at certain periods of time.

An important problem is that many appliances, if not maintained in a particular way may fail, or fail earlier. This is often referred to as the “run to fail” problem, where appliances do not receive required maintenance (which may be quite inexpensive), and therefore the appliance degrades to the point that it must be replaced or repair has become much more expensive, possibly so expensive that replacement of the appliance is the most cost effective solution.

From a manufacturer's perspective, if appliances run to fail, then this can harm brand reputation. From a service business perspective, they may be losing revenue if there aren't systems or solutions that help connect them to consumers better, and manage service calls better.

Self-serve maintenance may involve providing tools and incentives for consumers to engage in particular maintenance actions at the required times and correctly. Adherence by consumers is generally not consistent and this can lead to problems.

For the most part service businesses have had to build out significant infrastructure and resources in order to address appliance servicing requirements of consumers. Service businesses generally have built out or obtained access to costly call centres (both in terms of human resources and technology infrastructure—even with outsourcing) in order to try to reach consumers and schedule service calls. Service businesses devise various programs to engage with consumers and attract and manage service calls. This often involves process design, training of sales personnel as well as service call personnel. Various technology and service aspects referred to herein may be collectively referred to as “service program”.

If it is the service business or an agent on their behalf trying to reach a consumer, this can be very challenging. Many people ignore call centre calls as they may assume that it is tele-marketers calling trying to sell a product or service that the consumer is not interested in. The consumer may very well be interested in speaking with an agent to arrange a service call, if they understood the implications for them if they do not proceed with the maintenance actions, however, many consumers do not have this information or knowledge.

From the perspective of the service business or their agent, a significant obstacle is that they may have little to no information regarding a particular appliance's current state. A service call agent may have access to certain information regarding the particular consumer that they are contacting. For example, at the time of purchase or at the time of registration of the warranty, information may have been collected and logged to a database that includes certain information regarding the consumer (such as their contact information) and also the particular appliance that they bought, i.e. make, model, year, extra features and so on.

The life cycle of appliances can vary, for a number of reasons. Appliances can be relatively complicated machines. Also, in order to manage the cost of an appliance they may be designed and manufactured in ways that do not promote consistent performance. Service programs may require access to up to date information regarding the state of an appliance, which is not readily available. Service businesses may not be aware of when is the required time to contact a consumer based on the current state of their appliance in the applicable life cycle. This removes opportunities for targeted communications, and also poses a challenge in delivering a compelling program messaging that the consumer is likely to act on.

Also, from a manufacturer's perspective, they are interested in receiving more information regarding the various parameters of the performance of their products in the field. Some simply do not have enough information which may result in product design challenges, and missed opportunities in improving products and therefore improving sales, and also promoting better brand engagement. Some manufacturers invest in consumer studies to obtain this information, but these typically are costly and time consuming. There is also a need for a mechanism for collecting up-to-date product performance information from the marketplace in an efficient manner.

The maintenance of many appliances may benefit from access to real time metrics regarding appliance performance, possibly to predict failure and take corrective action at a time and in a way that promote appliance health and prolonged life.

Service businesses may benefit from access to real time metrics in order to target consumers at an opportune time when consumers will understand the value of maintenance services in that the need for these services is imminent, and without them the consumer may need to incur more expensive maintenance, or the appliance may fail triggering inconvenience and having to incur more expense.

Also, the service business may not have access to information as to when a particular appliance may have been the object of maintenance actions, and if so exactly what they were, who performed them and what was their training or certification was.

Also, consumers may not necessarily engage with a single organization in order to access maintenance services. Warranties tend to discourage consumers from utilizing different organizations. However, especially where a critical appliance has broken down, and for example a technician from a service business authorized by the manufacturer cannot come quickly enough, or their emergency fees are very high, it is quite common for a consumer to turn to someone else, often a local service business. Yet proper maintenance of the appliance may depend on being able to capture maintenance actions from multiple organizations.

Consumers generally have to incur the inconvenience of having to call a call centre and schedule a time, as opposed to using for example a web service to do so. The time windows provided by service technicians is normally quite extensive, for example, four hours. Many consumers take time off of work to be available for these service call windows. This may be inconvenient.

However, these service calls tend to be initial service calls, where the service technician may perform diagnostic operations to obtain information regarding the nature of the problem. Normally, for many first service calls, the service technician may have certain information regarding the nature of the call collected by the call centre, however, this information is often not as reliable as diagnostic information. The service technician may not have the parts required to repair the appliance, or sometimes may not have the training to repair the particular problem with the particular appliance. And for these and other reasons, the initial service call is normally followed by a further service call where the problem is actually fixed. Many consumers often assume that the problem will be repaired in the first service call, and the prospect of having to schedule and attend a further service call is often not welcomed by consumers. Also, especially if the appliance has already failed, this means further inconvenience to the consumer.

Furthermore, from the perspective of allocation of resources of the service business the initial service call still requires resources, and yet the value perceived by the consumer is very small to nothing. This poses a challenge in monetizing or making a profit on the initial service call.

As an illustrative example, the following provides example disadvantages from the perspective of service businesses. (A) Service businesses are generally reacting to problems and already dealing with unhappy customers, especially if the appliance has already run to failure. This makes the management of customer relations more difficult and expensive. A particular problem is the fact that when an appliance has run to failure, a replacement part must be obtained as quickly as possible, however, with older appliances obtaining parts can be time consuming. The urgency can translate into increase in costs that an unhappy customer is not likely to want to pay for. (B) Service technicians may not have the knowledge to fix a particular problem but there may not be resources available to learn how to fix a particular problem. As a result experienced and expensive technicians tend to be sent for follow up calls, and less experienced technicians who could learn to complete other maintenance actions either require fairly expensive training or do not acquire the additional skills. (C) Service businesses generally do not have the opportunity to make service calls before failure occurs. They do not have the opportunity to target consumers, and make service calls, before failure is about to occur. For example, there is no way to know how many cycles a dishwasher has been run and at what conditions (high temperature, extra long ‘pots and pan’ cycle, etc.), and how this compares to typical machine trends of other users. For example, maybe the set of conditions as mentioned above leads to faster drive belt wear and hence failure, meaning it is better to change the belt sooner than normal. There exists a need for a mechanism to obtain this information, and act on this information, or at least an alternative.

In some cases manufacturers run the call centre, and then attempt to manage local independent service technicians, and book them and ensure that they have the right inventory. This may be costly and cumbersome.

Computerized maintenance management systems (CMMS) may be designed to digitize data and manage a maintenance department's activities such as work orders, scheduling, reporting, inventory, and personnel, for example. However, proper use may be generally fraught with difficulty due to the complex nature, significant cost, and non-intuitive or confusing workflows. This may not lead to improved efficiencies or productivities of a maintenance department, or to a company's bottom line. Furthermore, there exists a need for integration with appliances or mechanisms to manage maintenance actions more efficiently, or at least an alternative.

The problems identified above may lead to lost productivity, increased downtime, reduced efficiencies and low competitiveness. This may be disadvantageous to consumers, service businesses, as well as manufacturers.

There is a need for platforms and solutions that address one or more of the mentioned problems, or at least provides alternatives to known solutions.

### SUMMARY

In one aspect, embodiments described herein may provide a computer system that is connected to the Internet and enables a plurality of network connected devices to access a novel and innovative maintenance service management platform. The computer system may be implemented as an Internet enabled computer platform that implements a multi-tenant architecture that enables multiple platform clients (for example service businesses and/or manufacturers) to populate the platform with various information regarding their products and offerings. A consumer area enables consumers to manage their information and maintenance schedule across several appliances and/or maintenance plans.

The computer system includes a data harvesting layer that extracts information from appliances or associated systems regarding the status of the appliances. This information is used to extract insights regarding the consumer's possible maintenance requirements. The computer system includes a series of intelligent features for automating or streamlining booking and completion of maintenance actions.

In another aspect, embodiments described herein may provide a CMMS configured to implement a preventative approach to maintenance of appliances or other consumer resources.
In another aspect, embodiments described herein may provide a computerized maintenance management system (CMMS) is provided that is connected to the Internet and enables a plurality of network connected devices to access a novel and innovative maintenance service management platform, the CMMS comprising:
   at least one data harvesting unit provided by at least one processor and at least one memory storing executable instructions to configure the at least one data harvesting unit to:
      collect data regarding a plurality of consumer resources and maintenance services for the plurality of consumer resources, wherein each of the plurality of consumer resources is associated with an identifier, and
      process the collected data to generate maintenance information;
   one or more computers linked to a server application, the computers and server application providing one or more utilities to:
      for each of one or more of the plurality of consumer resources:
         determine the current status of the consumer resource using the collected data and maintenance information;
         determine one or more relevant maintenance profiles for the consumer resources using the identifier for the consumer resource;
         compare the current status to the one or more relevant maintenance profiles; and
         based on the one or more relevant maintenance profiles trigger one or more maintenance action and/or product or service requirements related processes, including at least one of booking of a service call, ordering of a part, remote diagnostic, remote update, generating an alert, and transmitting a notification.
In some embodiments, the system may further comprise: one or more connected consumer resources of the plurality of consumer resources, wherein the connected consumer resources are coupled to the at least one data harvesting unit for the automatic provision of the collected data.
In some embodiments, the system may further comprise: a plurality of computer terminals linked to a computer network, each computer terminal associated with an individual, wherein each individual is associated with one or more of the plurality of consumer resources; and
   wherein the one or more computers are made available to users of a plurality of clients using the computer terminals; and
   wherein the CMMS (i) tracks activities of users across at least two clients in connection with the management of resources, (ii) extracts insights from such activities, and optionally (iii) enables users to upload the data regarding the plurality of consumer resources and the maintenance services, and extracts from such collected data and the maintenance information an information set;
   and wherein the CMMS analyses the information set and generates automatically the maintenance action and/or product or service requirements related processes, and communicates maintenance action and/or product or service requirements related processes to one or more clients for whom it is determined that the suggestions are relevant.
In some embodiments, the maintenance action and/or product or service requirements related processes include preventative maintenance actions.
In some embodiments, the one or more computers monitors the performance of a set of consumer resources associated with varying maintenance actions to determine the current statuses, and extracts best practice information based on the consumer resources that perform the best, and uses these best practices to generate the maintenance action and/or product or service requirements related processes.
In some embodiments, the system may further comprise: the best practice information includes a suggested maintenance schedule for a consumer resource.
In some embodiments, the system may further comprise: one or more data filters for filtering confidential information, sensitive information, or information that a client elects not to share from the maintenance action and/or product or service requirements related processes.
In some embodiments, the system may further comprise: one or more inventory management tools to provide an inventory of equipment resources regarding the plurality of consumer resources, wherein the utilities are further configured to automatically order an equipment resource from a supplier based on the maintenance action and/or product or service requirements related processes.
In some embodiments, the system may further comprise: a social networking platform that enables clients to selectively share maintenance related information, wherein the maintenance related information is correlate for a particular consumer resource using the identifier for the particular consumer resource.
In some embodiments, the social networking platform enables clients to aggregate product or service requirements for the plurality of consumer resources in order to share costs.
In some embodiments, the social networking platform enables clients to permit inventory information regarding the plurality of consumer resources to be accessible, or accessible in part, by one or more other clients selected by them, in order to share inventory, including equipment resources or parts inventory for the plurality of consumer resources.
In some embodiments, the one or more utilities allows clients to search for required service providers or parts from networked clients based on service provider or part parameters and geographic parameters.
In some embodiments, the system may further comprise: the CMMS includes or connects to a semantic analyzer for determining that two or more information sets relate to a similar resource or to the same resource.
In another aspect, embodiments described herein may provide a method for computerized maintenance management of consumer resources, the method comprising
   providing at least one data harvesting unit by at least one processor;
   collecting, using the at least one data harvesting unit, data regarding a plurality of consumer resources and maintenance services for the plurality of consumer resources, wherein each of the plurality of consumer resources is associated with an identifier, and
   processing, using the at least one data harvesting unit, the collected data to generate maintenance information;
   using one or more computers linked to a server application for providing one or more utilities, for each of one or more of the plurality of consumer resources:
      determining the current status of the consumer resource using the collected data and maintenance information;
      determining one or more relevant maintenance profiles for the consumer resources using the identifier for the consumer resource;
      comparing the current status to the one or more relevant maintenance profiles; and
      based on the one or more relevant maintenance profiles triggering one or more maintenance action and/or product or service requirements related processes, including at least one of booking of a service call, ordering of a part, remote diagnostic, performing a remote update, generating an alert, and transmitting a notification.
         In some embodiments, the method may further comprise:
   linking one or more computer terminals to one or more computers executing a computerized maintenance management system (CMMS), implemented as a computer network service made available to users of a plurality of clients using the computer terminals, wherein each computer terminal is associated with an individual;
   two or more clients permitting the CMMS to (i) track activities of users across the participating clients in connection with the management of the plurality of consumer resources, (ii) extract insights from such activities, and optionally (iii) enabling users to upload information or documents related to the plurality of consumer resourcea, thereby extracting an information set;
   executing an analytics and suggestion routine, the analytics and suggestion routine analyzing the information set and generating automatically the maintenance action and/or product or service requirements related processes for clients; and
   at least one client receiving the maintenance action and/or product or service requirements related processes at one or more computer terminals.
In some embodiments, the method may further comprise: aggregating maintenance data received via social networking platform to populate one or more of the maintenance profiles.
In some embodiments, the method may further comprise: filtering the maintenance action and/or product or service requirements related processes for relevance to a participating client, and transferring to the participating client relevant suggestions.
In some embodiments, the method may further comprise: suggesting preventative maintenance actions.
In some embodiments, the method may further comprise: monitoring performance of the plurality of consumer resources associated with varying maintenance actions, and extracting best practice information based on the resources that perform the best, and using these best practices to generate the maintenance action and/or product or service requirements related processes.
In some embodiments, the method may further comprise: filtering confidential information, sensitive information, or information that a client elects not to share, from the maintenance action and/or product or service requirements related processes.

In one implementation the computer system may include one or more tools that (i) track activities of users in connection with the management of consumer resources, (ii) extracts insights from such activities, and/or (iii) enables consumers and other users to upload information or documents related to resource management to the computer system. The computer system includes a series of intelligent features that use (i), (ii) and/or (iii) to suggest automatically maintenance actions and/or product or service requirements for the consumer resources to users.

In one implementation, the computer system may provide a CMMS, and users configure a list of consumer resources (e.g. appliances, machines or other products) that require maintenance. The CMMS is configured to include one or more intelligent features that streamline the process of setting up a platform client's maintenance requirements on the CMMS, and automate one or more maintenance related actions.

In one aspect, a cloud based CMMS is provided that enables management or maintenance of various consumer assets (such as for example equipment) including for example: (A) Logging of various consumer resources or assets requiring maintenance (“assets”); (B) Generation and tracking of maintenance schedules for the consumer assets. This may include tracking various maintenance “activities” associated with an asset (for example performing a particular diagnostic operation, or maintenance operation). Activities may be “required” or “recommended”. The platform may be configured to generate reminders and/or calendar entries based on activities. The platform may enable an administrator to assign activities to particular personnel and also send reminders to their mobile phone for example based on user defined parameters. (C) Executing activities, including on an automated basis. This may include checking an inventory system to see if a part required for an activity is available, or ordering a part automatically from a supplier. As part of the execution related features, the CMMS may also include part management tools (including order processing and delivery management).

In another aspect, a system for managing maintenance of consumer resources such as appliances, machines, equipment or devices, is provided comprising: (A) a plurality of computer terminals linked to a computer network, each computer terminal associated with an individual; and (B) one or more computers executing a computerized maintenance management system (CMMS) as a computer network service made available to users of a plurality of clients using the computer terminals; wherein the CMMS (i) tracks activities of users (across at least two clients) in connection with the management of consumer resources, (ii) extracts insights from such activities, and optionally (iii) enables users to upload information or documents related to resource management to the system, and extracts from such information or documents an information set; and wherein the CMMS analyses the information set and generates automatically one or more suggested maintenance actions and/or product or service requirements for clients (“suggestions”), and communicates the suggestions to one or more clients for whom it is determined that the suggestions are relevant.

In another aspect, the CMMS monitors the performance of a set of consumer resources associated with varying maintenance actions, and extracts best practice information based on the consumer resources that perform the best, and uses these best practices to generate suggestions.

In another aspect, the CMMS includes one or more data filters for filtering confidential information, sensitive information, or information that a client elects not to share, from suggestions.

In another aspect, the system comprises a social networking platform that enables clients to selectively share maintenance related information. In yet another aspect, the social networking platform enables clients to aggregate product or service requirements in order to share costs.

In a still other aspect, the social networking platform enables some clients to permit their inventory information to be accessible, or accessible in part, by one or more other clients selected by them (networked clients), in order to share inventory, including parts inventory.

In another aspect, the CMMS allows clients to search for required parts from networked clients based on part parameters and geographic parameters. In yet another aspect, the CMMS automatically detects gaps in a first client's inventory based on its resources, and automatically suggests inventory available from its networked clients.

In another aspect, the CMMS comprises: (A) the computer network service; and (B) a local computer system component that connects to the computer network service; wherein the local computer system includes an export utility that permits a client to selectively determine the information to be exported to the computer network service for storage to a data store for use in routines using information across a plurality of clients.

In yet another aspect, the CMMS includes or connects to a semantic analyzer for determining that two or more information sets relate to a similar resource or to the same consumer resource.

In another aspect, the suggestions include: a maintenance action; or purchase of particular new piece of equipment, or part for the appliance or other consumer resource.

In another aspect, a method is provided for managing maintenance of consumer resources such as appliances, machines, equipment or devices, the method comprising: linking a plurality of computer terminals to a computer network, each computer terminal associated with an individual, and linking one or more of the computer terminals to one or more computers executing a computerized maintenance management system (CMMS), implemented as a computer network service made available to users of a plurality of clients using the computer terminals; two or more clients (“participating clients”) permitting the CMMS to (i) track activities of users across the participating clients in connection with the management of consumer resources, (ii) extract insights from such activities, and optionally (iii) enabling users to upload information or documents related to resource management to the computer system, thereby extracting an information set; the CMMS executing an analytics and suggestion routine, the analytics and suggestion routine analyzing the information set and generating automatically one or more suggested maintenance actions and/or product or service requirements for clients (“suggestions”); and at least one client receiving suggestions at one or more computer terminals.

In this respect, before explaining at least one embodiment in detail, it is to be understood that embodiments described herein may not be limited in its application to the details of construction and to the arrangements of the components set forth in the following description or illustrated in the drawings. Other embodiments are capable of being practiced and carried out in various ways. Also, it is to be understood that the phraseology and terminology employed herein are for the purpose of description and should not be regarded as limiting.

### BRIEF DESCRIPTION

Embodiments will be better understood and objects of the invention will become apparent when consideration is given to the following detailed description thereof. Such description makes reference to the annexed drawings wherein:

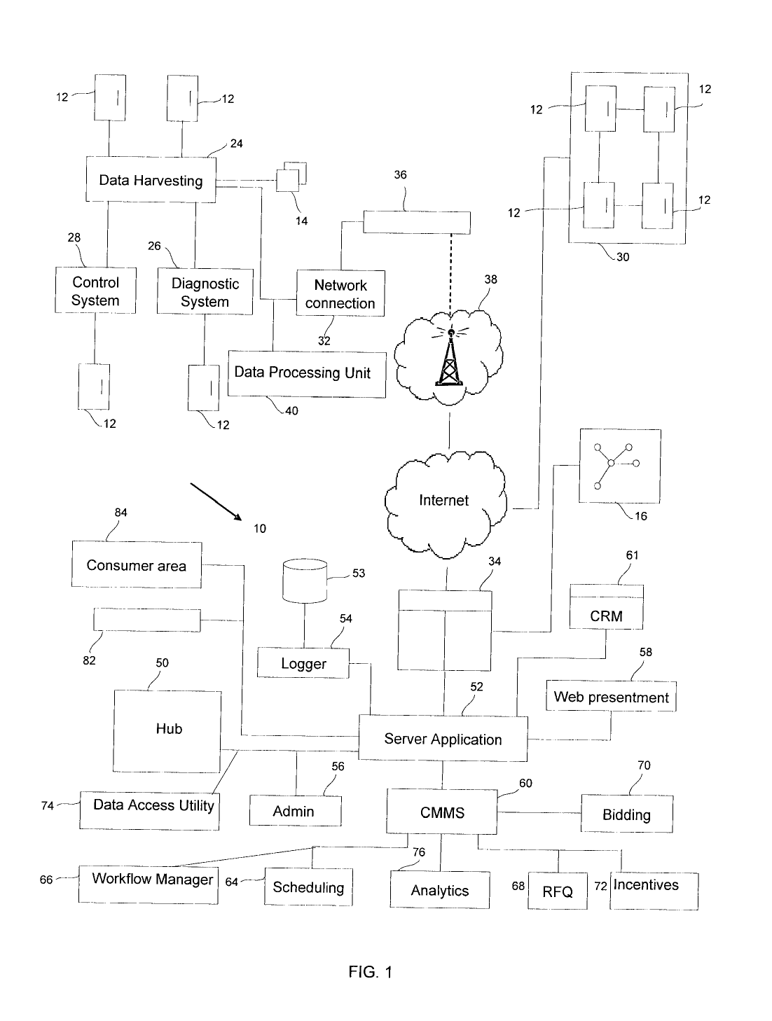

FIG. 1 is a system diagram of an example maintenance system according to some embodiments;

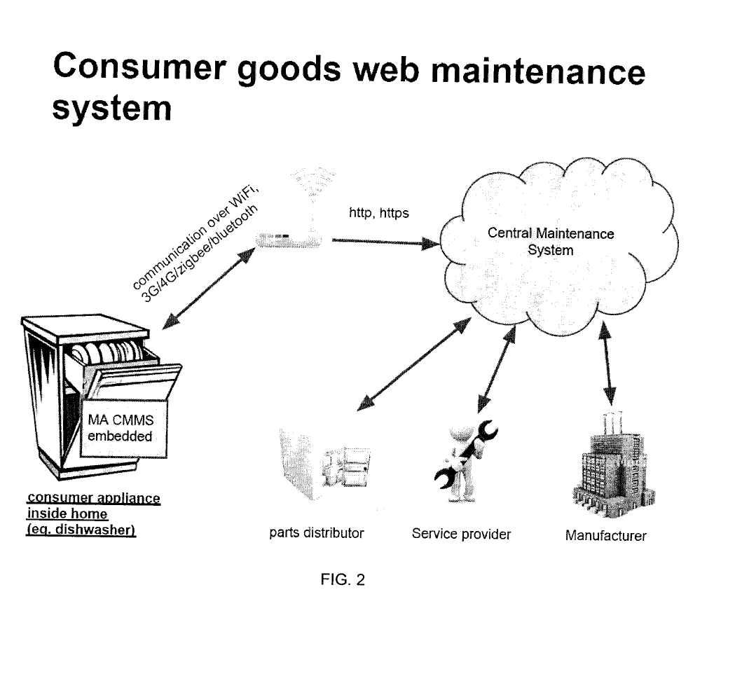

FIG. 2 is another system diagram illustrating another example maintenance system according to some embodiments;

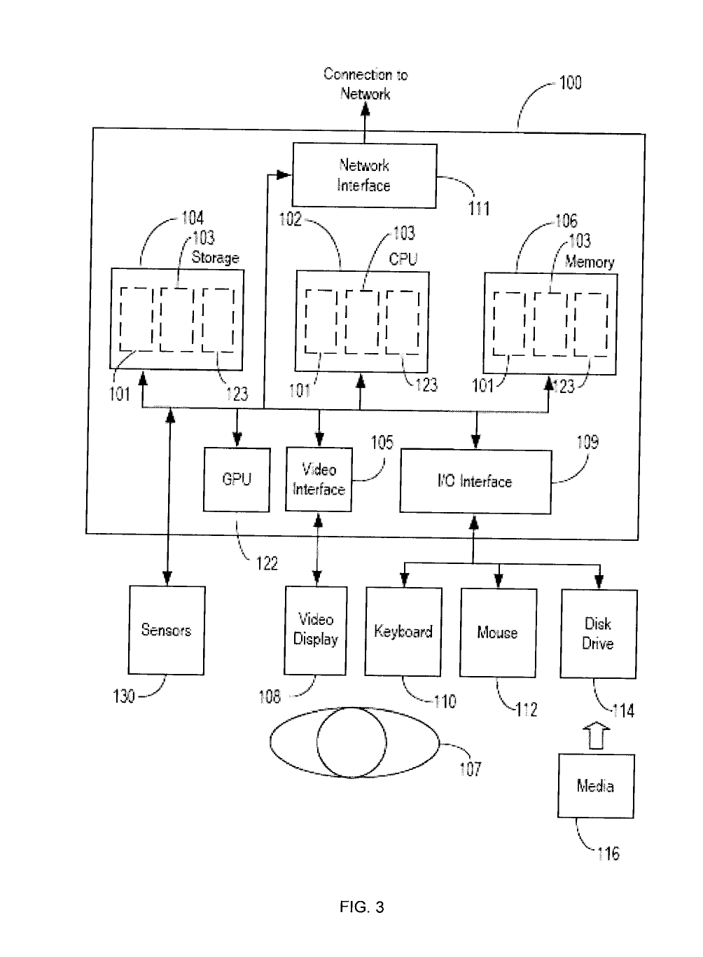

FIG. 3 illustrates an example consumer computer system according to some embodiments.

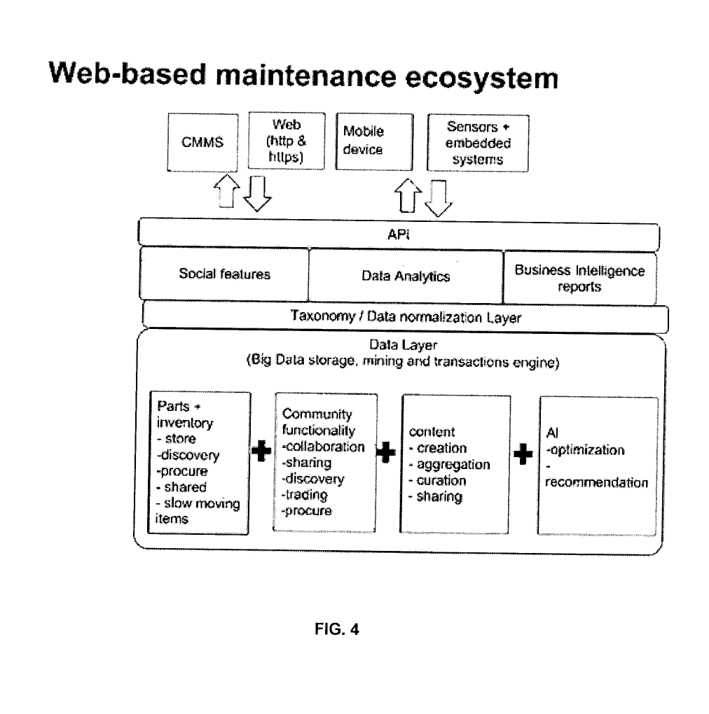

FIG. 4 is a further system diagram illustrating another example maintenance system according to some embodiments;

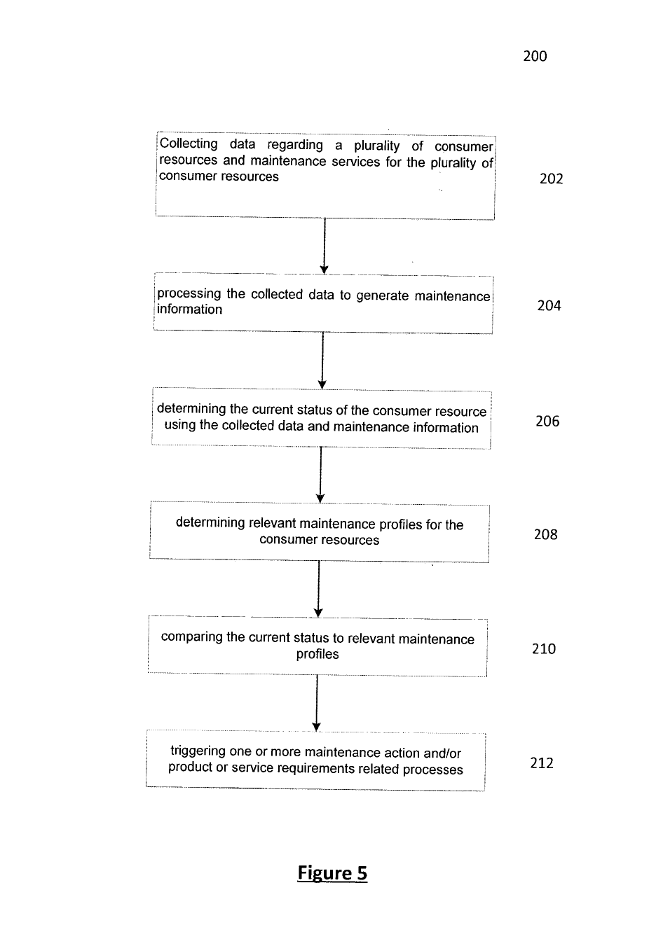

FIG. 5 is flow chart of a method for consumer maintenance according to some embodiments;

In the drawings, embodiments are illustrated by way of example. It is to be expressly understood that the description and drawings are only for the purpose of illustration and as an aid to understanding, and are not intended as a definition of the limits of embodiments.

### DESCRIPTIONS OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may automatically collect data from various appliances and consumer resources, process the data, initiate maintenance activities for the consumer resources, remotely control the consumer resources, aggregate data from multiple consumer resources and service providers to generate data metrics to improve, predict and suggest maintenance activities, automate the scheduling of maintenance activities based on current state of consumer resources, and so on.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In this disclosure, by “social networking platform” means any computer network implemented application platform that is operable to generate a series of web pages so as to define a series of user interactions and/or workflows, including social media interactions, that define a social networking environment.

“Friends” refers to two or more users of a social networking platform who share one or more social interaction privileges by operation of the social networking platform, based on one or more pre-established rules. Conferring the social interaction privileges may require user acceptance and/or may be assigned automatically by the social networking platform based on the rules.

“Social media interactions” refer to the various interactions between users of a social networking platform (including “friends”), the interactions including various communications (such as platform messaging, instant messaging, videoconferencing, voice messaging, etc.), uploading or posting content in one or more media, downloading content in one or more media, watching content in one or more media, reviewing or rating content including “objects”, taking a quiz, selling or trading items such as “objects”, and so on.

“Objects” include any content or media object that may be used or consumed in connection with social interactions, such as for example a social feed, a message, a use case, a video, quiz, a tip, a discussion, a digital good, etc.

### Maintenance Service Management Platform

As shown in FIG. 1, an intelligent, consumer side maintenance monitoring and maintenance action triggering computer platform is provided (the “platform” (10)) according to some embodiments. The platform (10) integrates the consumer side in the management of maintenance of appliances and other consumer resources. The platform (10) includes functionality to extract information relevant to management of maintenance from the consumer environment. This information is used to automate certain maintenance management aspects in an intelligent manner.

The platform (10) incorporates a plurality of novel and innovative intelligent features for the maintenance management of consumer resources by collecting data regarding the consumer resources, determining current statuses for the consumer resources (i.e. current operating state, any detected issues, etc.), mapping the collected data to one or more relevant maintenance profiles, and triggering one or more maintenance action and/or product or service requirements related processes. Examples include booking of a service call, ordering of a part, remote diagnostic, performing a remote update, generating an alert, and transmitting a notification.

The platform (10) includes or links to a number of web platforms, and incorporates social media features, that improve on the way in which consumers can obtain maintenance services, and also that improve communications between the various stakeholders involved the provision of maintenance services.

### Data Harvesting Layer

In one aspect of embodiments described herein, as shown in FIG. 1, a data harvesting layer (20) is provided. The data harvesting layer (24) may consist of one or more components or units that are configured to obtain information relevant to maintenance actions for one or more appliances (12) associated with the platform (10) (referred to as “maintenance information” (14)). The data harvesting layer (24) may collect maintenance information directly from the consumer or consumer resource, or may process data collected from the consumer or consumer resource to derive maintenance information. Different data harvesting units may be associated with different consumers and consumer resources. The data harvesting layer may be made up of a number of data harvesting units arranged in various configurations or tiers. A data harvesting unit may collect data from a number of connected data harvesting units, and process the collected data to derive maintenance information, for example.

Maintenance information (14) for example may include: make, model, serial number, purchase date, warranty information, service and repair history, runtime data, system history, environmental conditions, and so on.

Relevant maintenance information (14) may be collected or extracted/derived by the data harvesting units (24). The data harvesting layer (24) may include for example one or more data harvesting units (24). The data harvesting unit (24) may consist of hardware, software and/or middleware that is configured to extract from an appliance (12) that is relevant to the operation of the platform (10).

The data harvesting layer (24) may be implemented using a server and data storage devices configured with database(s) or file system(s), or using multiple servers or groups of servers distributed over a wide geographic area and connected via a network. The data harvesting layer (24) may be connected to a data storage device directly or via to a cloud based data storage device via network. The data harvesting unit (24) may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. The data storage devices may be used to provide a persistent store for a user's personal learning record. According The data harvesting layer (24) may collect and store maintenance data and data regarding consumer resources, index the data for storage such as via a unique identifier for each consumer resource, and enable subsequent search and retrieval.

The data harvesting layer (24) may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Remote management server 16 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

In one implementation, the data harvesting unit (24) may consist of one or more components, that may be integrated with the appliance (12) or other consumer resource by the manufacturer, or that may be installed as part of an after-market installation.

Some appliances (12) may include an onboard diagnostic system (26) that may be part of an appliance (12) such as for example a washing machine. The data harvesting unit (24) may be designed to interface with the onboard diagnostic system (26) in order to extract maintenance information (14) and collect other data regarding the consumer resource.

Alternatively, some appliances (12) may not include an onboard diagnostic system (26). The data harvesting unit (24) may include electronics that enables the monitoring of appliance functions and/or the performance of diagnostic operations in order to generate maintenance information that supports maintenance actions. For example, the data harvesting unit (24) may be configured to connect to one or more sensors that are part of an appliance (12). The data harvesting unit (24) may also connect to an appliance control system (28) in order to obtain maintenance information (14). The appliance control system (28) may also be used to remotely control, configure or otherwise modify the appliance as part of a maintenance action, for example.

The data harvesting unit (24) may be implemented by, or may connect, to an existing system or systems connected to the appliance (12). A consumer premise may have one or more devices that are configured to collect data from appliances (12), for example in connection with operation of a power management system. Various platforms and protocols may enable collection of information for appliances (12) for example how often they are used, how much power they consume, current state, and so on. This information may provide maintenance information (14) or may be processed in order to yield maintenance information (14).

In one implementation of the present invention, the data harvesting unit (20) may consist of one or more components that connect to an existing appliance monitoring network (30). The appliance monitoring network (30) may include appliance control functions, for example shutting off certain appliances (12) when a house is unoccupied, in order to save power. The data harvesting unit (20) may include or link to functionality to connecting to additional appliances (12) that may not be part of the appliance monitoring network (30).

The data harvesting unit (20) may include a network connection utility (32) connecting to an available wired or wireless network in order to access the Internet, and via the Internet central server computer (34). In one aspect, the network connection utility (32) may include functionality to connect to a wireless router (36). The wireless router (36) may already be a part of an appliance monitoring network (30), or may be linked to another system such as a home alarm system. The network connection utility (32) may also enable data communications via a wireless network (38).

The platform (10) may include a data processing unit (40). For certain applications, the appliances (12) may not provide on their own maintenance information (14), in the sense of information on which the platform (10) can act to trigger platform processes related to maintenance actions. The data processing unit (40) implements one or more utilities or processes that enable data collected from appliances (12) to be used to generate maintenance information (14).

The data processing unit (40) may implement one or more analytical utilities or processes that enable the extrapolation of maintenance information (14) from collected raw data regarding the performance of the appliance (12).

For certain applications, the data processing unit (40) may be implemented as part of the data harvesting unit (24). In this representative implementation of the platform (10), the data processing unit (40) is configured to process information related to appliances (12) and apply one or more data processing rules (42) that determine when one or more maintenance information messages (44) are to be sent to the central server computer (34), and the contents of such maintenance information messages.

For example the data processing unit (40) may be configured to only send information to the central server computer (34), in the form of maintenance information messages (44), when based on application of the data processing rules (42) the data processing unit (40) determines that maintenance action is required, or when new maintenance information is received, a change in status occurs, a trigger event occurs, and so on. The data processing unit (40) may also aggregate collected raw data from other consumer resources (shared via e.g. a social networking platform) to generate predictive or inferred maintenance information. Data may be tagged with an identifier for a particular consumer resource to enable the data processing unit (40) to aggregate the collected data on a per identifier basis. This enables the platform (10) to leverage the collective power of shared information to service individual consumers and other users using data that would otherwise not be available to them.

For example, a data harvesting unit (24) may be connected to an appliance (12) that is a washing machine for example. The data harvesting unit (24) may include programming that enables the data harvesting unit (24) to obtain information regarding the washing machine, including for example its model and make. Alternatively, the data harvesting unit (24) may obtain the serial number of the washing machine, and using this information initiates a communication with the central server computer (34) in order to initiate an up to date set of data processing rules (42) for the particular washing machine. Appropriate data processing rules (42) for a particular appliance (12) may vary from time to time, for example, based on up to date information regarding best practices for extending the life cycle of a particular appliance (12). The platform (10) of the present invention, as explained below, enables the collection and analysis of the information required to update such best practices iteratively. A data harvesting unit (24) may send the collected information to a central server 34 or data processing unit (40) for aggregation with collected data for the same or similar type of consumer resources, sales and marketing data, manufacturer data, recall data, service, data, and so on in order to determine and suggest maintenance actions. For example, the maintenance action may be a call to a consumer to schedule a maintenance action anticipating a maintenance problem, which call would be more relevant to both the consumer and the service provider.

The data harvesting unit (24) may be configured to extract information regarding the usage or performance of the particular washing machine, and possibly other related parameters. Usage of such an appliance may vary significantly from household to household. The data processing rules (42) may include rules for determining when, based on the data processing rules (32) certain maintenance actions may need to be initiated, such as for example the notification of the central server computer (34) that a particular part, such as a washing machine belt may need to be replaced soon.

The data processing unit (40) may also be programmed to generate for example one or more appliance health scores or measures, and optionally when one or more of these health scores or measures reach certain levels or thresholds, the data harvesting unit (24) may send one or more maintenance information messages (44) to the central server computer (34). Accordingly, the processing of data may trigger notification or messaging to suggest maintenance actions.

The data harvesting layer (20) may also include CMMS type functionality in the sense that the data harvesting layer (20) may implement intelligent features that by interoperating with the central server computer (34) enable the appliance (12) to in essence manage its own maintenance.

### Central Hub

As shown in FIG. 1, the platform (10) includes one or more central hubs (50).

The central hub (50) may be implemented by the central server computer (34) or by a server farm. The central hub (50) may also be implemented by a cloud network. The central hub (50) in one implementation, may include a server computer program (52) or application repository that implements one or more utilities for delivering the maintenance management services.

The central hub (50) may be implemented using a server and data storage devices configured with database(s) or file system(s), or using multiple servers or groups of servers distributed over a wide geographic area and connected via a network. The central hub (50) may be connected to a data storage device directly or via to a cloud based data storage device via network. The central hub (50) may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. The data storage devices may be used to provide a persistent store for a user's personal learning record. The central hub (50) may collect and store maintenance data and data regarding consumer resources, index the data for storage such as via a unique identifier for each consumer resource, and enable subsequent search and retrieval.

The central hub (50) may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Remote management server 16 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

The server application (52) includes a logger (54) that logs information received from a plurality of data harvesting units (24) to a database (53). The information and data may be logged in association with a user identifier, a resource identifier, and so on. The identifiers may facilitate subsequent analysis, retrieval, correlation, and so on. The database (53) may be implemented so as to ensure that users are only able to access information that they have been authorized to access, based on setting established using an administrative utility (56).

Various network architecture implementations of the platform (10) are possible. For example, the data harvesting layer (20) may be configured so that all information that may be relevant to the generation of maintenance information (14) may be sent to the central server computer (34) which may be implemented as a cloud service for example.

The central server computer (34) may include one or more utilities for managing maintenance services.

The central hub (50), in one implementation provides a central CMMS, which several service businesses may access to manage the provisional of maintenance services to their customers.

In one aspect, the central hub (50) enables communications between a variety of stakeholders, namely consumers, manufacturers, distributors, service businesses, and other members of the supply chain, as shown in FIG. 2.

The server computer program (52) may include a web presentment utility (58). The web presentment utility (58) defines one or more web areas that enable for example service businesses to log into a defined web area, establish their preferences using the administrative utility (56), and access a series of maintenance management related utilities.

Maintenance Management Platform with Integrated Social Features

The platform (10) may include a number of features associated with a CMMS. In fact the platform (10) may include a CMMS (60), as shown in FIG. 1.

For example, the platform (10) may also extend the CMMS described in the co-pending patent application U.S. patent application Ser. No. 12/363,583 of the inventors, by incorporating the consumer side features described in the present disclosure., which is incorporated herein by this reference. Various features of the CMMS described therein may also be used in connection with the CMMS (60) described herein.

The platform (10) may link to a number of different types of CMMS, thereby providing enhanced service call management functions to these CMMS.

As shown in FIG. 1, in one aspect, a novel and innovative, web based CMMS (60) is provided that includes a social networking layer, which may be implemented using a social networking platform (16) for enabling for example service technicians to co-operate through the platform (10) by sharing information and optionally resources, and aggregating requirements for products and services related to provision maintenance services, and thereby lowering costs, as further explained below.

The platform (10) utilizes a multi-tenant architecture that enables multiple platform appliances (12) to populate the platform (10) (for example a database (14) associated with the platform (10)) with various information regarding their resource management requirements and status updates. Significantly, the resource management platform (10) includes a social networking layer, which may be implemented using a social networking platform (16) for enabling platform appliances (12) to co-operate through the platform (10) by sharing information and optionally resources, and may also enable aggregation of requirements for products and services related to resource management, thereby lowering costs.

A consumer manages their resources individually and do not share information and resources with one another. Benefits may be realized by various entities, including consumers, service providers, manufacturers, if a mechanism can be found to motivate users to share information and resources. The objective can be met by providing a resource management platform (10) that provides tools that integrates social features that enable specific social media interactions that enable users to co-operate for shared benefit. These benefits may include greater efficiency, more rapid access to important notifications regarding maintenance, lower costs, and so on.

Open social media interactions (open sharing of information and open communications within established networks) between platform consumers who may not be acceptable in view of privacy issues. The operator of the platform (10) acts as a trusted intermediary in enabling information sharing and/or communications between platform clients in a particular way, so as to promote sharing of information and resources for shared benefit, while addressing the concerns of many participating users in maintaining the confidentiality of information and privacy. The platform (10) is configured to (A) provide useful resources to users in a multi-consumer environment that segregates access for a first set of consumer information, (B) based on predetermined rules accepted by platform users, aggregate a second set of consumer information (which may be a sub-set of the first set of consumer information), and store the second set of consumer information to a central hub (50) or a section of the database (14) that is tagged so as to be available to one or more shared services that are made accessible to platform clients.

The platform (10) includes a data access utility (74). In one implementation, the data access utility (74) is used to manage access to various resources of the platform (10) for example by associating an access profile with usernames/passwords associated with a particular platform client. The data access utility (74) may be used to configure shared services made available by the platform (10) on a platform client by platform client basis. The platform (10) is configured to define, through the use of the data access utility (74), a set of rules for establishing the eligibility of a particular platform appliance (12) to particular shared services. For example, platform clients may be required to provide access to information, or agree to share available resources, through the platform (10) with other platform clients in order to access certain shared services. This mechanism may be used to motivate platform clients to share information and resources to a greater and greater extent. Conversely, platform clients may retain a certain amount of control over the information/resources that they agree to share through the platform (10). An important feature in driving adoption and usage of the platform (10) in that users may be attracted to the platform (10) but generally wish to first share information/resources in a selected domain, and thereafter if the experience has been positive (for example the benefits are seen to outweigh the perceived risks of engaging with other enterprises through the platform), then generally the platform clients expand their engagement with the platform, which across multiple platform clients is in the interest of the platform clients and also the operator of the platform (10).

The platform (10) may be implemented as a cloud network implemented computer system. In one aspect, a cloud based CMMS (60) may be provided that enables management or maintenance of various consumer assets (such as for example appliances).

The CMMS (60) is also linked to a transaction utility for enabling platform clients to order products/services related to their maintenance requirements directly through the platform (10). This provides convenience to the platform clients, and also enables the operator of the platform (10) to deliver certain value-added services to platform clients that require access to the transaction information.

The platform (10) may include a service delivery platform which is best understood as a series of utilities that enable the platform (10) to provide value added services to the various platform clients, for shared benefit, leveraging the information made available across multiple platform clients.

In one aspect, embodiments described herein may provide a cloud based CMMS (60) that enables management or maintenance of various enterprise assets (such as for example equipment) including for example:

(A) Logging of various appliances requiring maintenance (for example specific appliances for which a service business is responsible for providing services);
(B) Logging information for consumers associated with particular appliances or other consumer resources, so as to store a profile on the database (53). Each profile may be indexed by a consumer identifier. There may also be profiles for particular appliances and consumer resources. Each profile may be indexed by a resource identifier, and also by a consumer identifier to distinguish between the same appliances owned by different consumers. The resource identifier may enable aggregation of data regarding the same or similar resource from different sources, such as social networking platform (16).

The platform (10) may also incorporate one or more mechanisms to populate consumer or appliance profiles, for example by harvesting information from social networks to complete profiles. The platform (10) may also include one or more utilities or processes for obtaining preferences from consumers regarding how they wish to receive maintenance services. The platform (10) may also include or link to a CRM platform (61), or may include CRM features. The CRM (61) may be used by personnel of the service business for example to obtain information regarding consumers. The CRM (61) may also be populated automatically with information for example obtained from manufacturers, subject to privacy rules.

The profiles for the consumers may for example contain information regarding their preferences in terms of service personnel; delivery of maintenance services; preferred turnaround time and so on.

A key aspect in regards to the preferences of consumers is their preferred parameters for communication. Consumers are often forced to communicate with service businesses by telephone because this is their preferred means of communication, but this is often not convenient to consumers who are usually busy with work during the office hours of the service business' call centre. One aspect of the platform (10) is that the consumer profiles will include the consumer's preferences as to means of communication, and this may be broken down based on time. The platform (10) incorporates a CRM (61) with a messaging utility for initiating and managing a variety of different communication related to booking and conducting maintenance actions. In one implementation, the messaging utility (61) includes email functionality and text messaging functionality, and also enables messaging through platforms that incorporate email such as FACEBOOK™.

(C) Generation and tracking of maintenance schedules. The platform (10) is configured to generate maintenance schedules for appliances (12) linked to the platform (10), including based on current information obtained through the data harvesting layer (20). This may include tracking various maintenance “activities” that are associated with an asset. For example, this may include performing a particular diagnostic operation or maintenance operation. Activities may be “required” or “recommended”. The platform (10) may be configured to generate reminders and/or calendar entries based on activities. The platform (10) may enable an administrator to assign activities to particular personnel and also send reminders to their mobile phone for example based on user defined parameters.
(D) Executing activities, including on an automated basis. For example, the CMMS may include or may link to a scheduling application (64). For example, the logging of maintenance information may trigger the automated scheduling of a service call, based on the preferences for the consumer, as obtained from his/her profile on the database (53). The scheduling application (64) may also integrate, based on consumer permissions, with one or more different calendars used by consumers. This information may also be logged to their profile. Various automated scheduling features may be used to streamline scheduling. Based on the harvesting of maintenance information, which may consist of information of imminent failure, consumers will be more motivated to respond to messaging related to maintenance.

Execution of activities may also include checking an inventory system to see if a part required for an activity is available, or ordering a part automatically from a supplier, based on consumer demand determined by the data harvesting layer (20). Significantly, the need for a particular maintenance service may be predicted, therefore making more intelligent staffing possible. Also, parts may be ordered in advance in the event that the platform (10) determines that a failure of one or more appliances (12) for example is imminent.

The CMMS (60) may also permit service businesses to build and improve profiles for service technicians who may be their employees or independent contractors who provide services to them. The CMMS (60) may help improve the matching of service technicians to jobs based on locations, skills level, personality and so on in order to provide a better experience to consumers.

In one aspect, the CMMS (60) includes a workflow manager (66) that may be configured in order to implement various maintenance processes related to completing maintenance management related workflow. The workflow manager (66) allows administrative users of service businesses registered to the platform (10) to define the parameters of service management workflows. The parameters may trigger suggested maintenance actions based on determined statuses for consumer resources, as well as previous workflows.

As part of the execution related features, the CMMS (60) may also include supply chain management tools (including order processing and delivery management).

In one aspect, the CMMS (60) may be configured to implement a preventative approach to maintenance of assets. A proactive approach to asset maintenance, based on early detection of problems and timely maintenance, promotes asset health and longevity. It is important to note that one particular contribution is the discovery that the integration of the social features described above enables the development of far more effective preventative asset maintenance, by leveraging the collective asset maintenance related know-how of platform clients. The collective data may be processed and aggregated based on the same or similar consumer resources to detect patterns in failure and other events, and recommend preventative maintenance actions. In accordance with a particular aspect of embodiments described herein, the CMMS (60) is acting on up to date information extracted from appliances (12), such as the current status of an appliance with regards to usage, performance, and other attributes such as age.

FIGS. 3a and 3b show representative interfaces that illustrate possible functions of the CMMS (60).

FIG. 4, illustrates an alternate, web-based maintenance ecosystem that implements aspects of the platform (10) described in this disclosure. The platform (10) implementation as illustrated in FIG. 4, an API is configured to connect for example to a third party CMMS; various web based applications; sensors and embedded appliance systems that may connect directly to the platform (10) to provide access to maintenance related information; and also mobile devices. The API is configured to make data available to a data layer, using a data normalization layer that enables data to be stored in a manner that supports big data storage, data mining, and transactions. The data layer enables the storage of information related to a number of functions including for example: parts & inventory; communication functionality; content creation; and analytics or artificial intelligence (including optimization and recommendation). The data layer feeds a number of features that are made available to authorized network connected devices, for example social features, data analytics, and business intelligence reporting.

### Information Sharing

In one aspect of platform, the multi-tenant CMMS (60) may be a meeting place for information sharing. Information sharing may be organized in an efficient and effective manner using the social networking platform (16). For example, service businesses and manufacturers may share valuable insights regarding products or consumers that help their respective businesses. Consumers may post information regarding products or maintenance services that is valuable to service businesses and manufacturers. Social media interactions may be used as mechanism to share information, resources and advice in a way that improves the performance of service technicians. This last aspect is especially important in integrating seamlessly independent service technicians for example in providing quality service locally.

In a still other aspect, the platform (10) may include one or more utilities that are designed to leverage the community of service technicians for example to complete tasks that help improve the provision of maintenance services overall, such as completion of checklists, service guides and so on.

Leveraging the community in connection with maintenance provides many benefits. Manufacturers often have very little information regarding how their products are actually used. A particular appliance may be used in different ways yet manufacturer provided operating conditions are generally provided in a generalized manner. The platform (10) provides a mechanism to identify different use profiles and to associate different maintenance rules with each use profile.

Manufacturers typically design their recommended operating procedures based on very conservative recommendations rather than actual performance data. Because manufacturers have limited access to actual performance data, even with attempts to make conservative recommendations, sometimes operating procedures are incorrect and furthermore it often takes some time before manufacturers realize this, and then communicate this to their customers. This sometimes is exacerbated by concerns regarding exposure to claims if equipment breaks down. The platform (10) significantly improves the access to accurate information obtained based on collective insight.

Another advantage is that platform clients can benchmark the performance of their products, and service businesses can access reports regarding products and/or their maintenance personnel based on industry standards that can be established automatically through the platform (10). Information of this nature may not have been readily available prior to development of the platform (10).

In another aspect, geo-location information or environmental information may be collected and associated with particular appliances. This information may be utilized to discover insights into appliance performance that may not have been otherwise available such as the impact of environmental conditions such as temperature or humidity on performance. Again, the collection of such information and making it available to the communities enabled by the platform (10) is far more likely to result in useful discoveries than individual analysis.

Each unique appliance may have its own maintenance requirements. An appliance is usually associated with information such as a product identifier, associated part numbers, description, associated photographs, associated part information, and an associated maintenance schedules, associated user and technical manuals and so on (“appliance related information”).

Some of this information is available from manufacturers, but it can be time consuming to try to organize this information in a way that it is readily accessible when it is needed. The staff responsible for maintenance often do not have access to administrative support with access to computers system such as document management systems. Moreover maintenance teams are usually under-resourced and do not have time to engage in administrative tasks such as storing equipment related information electronically in an organized fashion. Yet, when a problem occurs, it is important for such information to be readily accessible to various maintenance personnel on an on demand basis, and preferably for example using a mobile device.=

Appliance related information from manufacturers for example is often subject to change and platform may receive data updates to keep information up to date. Also, updates from manufacturer may often relate to multiple equipment models and therefore linking an update to a particular piece of equipment can be time consuming or difficult to manage. The linking and updates may be automatically managed by platform (10).

The platform (10) includes a data import utility that is designed to link to online databases made available by manufacturers for example, to extract information required to populate a data record for a particular appliance. The data record or profile, by operation of the platform (10) acts as a unified repository for information concerning a unique appliance. This unique repository inherently avoids duplicate records for the same appliance, and the resulting confusion and inefficiencies.

The data import utility is configured to automatically extract relevant information or files, and link them to appropriate fields of the applicable data record. Alternatively, personnel engaged by the operator of the platform (10) can extract and store this information.

The platform (10) may include one or more utilities that are designed to leverage the community of platform clients to engage in crowd sourced completion of tasks that benefit the platform clients in aggregate. The incentive platform may be leveraged to motivate users to complete data records with for example information from manufacturers. More importantly, platform clients can complete a data record with their own associated information or observations, and this information (subject to permissions as configured by platform clients using the data access utility) is then shared with other platform clients, or a defined sub-set of platform clients.

The associated information may include for example platform client generated:

(a) corrections or additions to information from the manufacturer that is relevant to maintenance;
(b) suggested maintenance schedule or tasks;
(c) best practice comments or suggestions related to maintenance;
(d) platform client generated maintenance checklists, guides or documentation (in a variety of formats); and
(e) maintenance related software tools developed by or for platform clients.

This may be stored in a maintenance profile for example.

A skilled reader will appreciate that these activities through the platform (10) provide access to better information regarding for example equipment—that is more accurate, more up to date, and may reflect accumulated knowledge or know-how that normally is not made available outside an enterprise. This type of information is often not even shared within an enterprise. Different members of a maintenance team for example may have access to different insights regarding different pieces of equipment for example. In other words, the aggregation of this type of information, made available by enterprise personnel through the platform (10) may also benefit that very enterprise.

A skilled reader who is knowledgeable regarding the relevant domain will appreciate that sometimes manufacturers provide information that is incomplete or inaccurate in part because this makes them more profitable. Manufacturers and their channel partners may benefit if equipment needs to be avoidably service or replaced (where this is not covered by warranty). They benefit if their customers stock more parts that are reasonably required, or if they do not have access to self-help strategies addressing maintenance issues on their own or increasing equipment longevity.

Significant advantages can be realized by consumers and other users if they have access to the information or know-how necessary to minimize these factors. However, it is very unlikely that a single user has the resources to collect and maintain this information for a single piece of complicated equipment, let alone across the various pieces of equipment that a typical enterprise likely runs.

The platform may address this issue by (A) creating one or more communities that possess in aggregate domain knowledge that can address these gaps in knowledge, and (B) motivating these communities to share this information, including by providing the information or documents mentioned above. These motivations may include basic commonality of interest, the fact that contributors will tend to also receive benefits from other platform clients. In addition, as discussed below, the present invention includes the incentive platform which may include specific incentives designed to motivate users to contribute information that provides a shared benefit.

Another advantage of this particular aspect of the invention is data normalization of relevant information such as part numbers and descriptions for a particular data record or profile, which in turn enables various analytical operations described above that would not have been otherwise possible.

More particularly, the mechanisms described provide an improved taxonomy for a variety of features of the analytics engine as described below.

The analytics engine may be configured to analyze maintenance documents for example by analyzing their content semantically and/or to tag maintenance documents automatically. The analysis or tagging may relate to the linking of the maintenance document to a particular data record, and therefore a particular appliance, if this connection has not already been determined based on user initiated tagging for example.

For example, the analytics engine enables the platform (10) to link in the platform (10) for example appliances or parts that relate to the same product, but for which there may be different product names or even part numbers. This is a common problem that can result in mistakes, inconvenience, lost time and lower productivity. For example, one distributor may use one part number for a product, and another distributor may use another part number for the same product. One implication is that businesses sometimes do not identify that the same part may be obtained from another source at a lower cost. The platform (10) enables these distortions to be minimized and removes market barriers by implementing semantic operations through the analytics engine so as to automate the mapping of different identifiers that relate to the same product or appliance.

The analytics engine may be used to automatically analyze product related information, and apply one or more semantic analysis operations to identify product information records that relate to the same information. In one implementation, related records may be identified to an administrator for confirmation. If confirmed, two or more identifiers that relate to the same product or service may thereafter be automatically mapped to one another for the purposes of the various operations that utilize those identifiers.

Confirmation of the relationship between different identifiers may be promoted to the platform's user base for confirmation, for example to selected users, whom the platform (10) has confirmed may have a higher than average knowledge based in a domain relevant to the product or service in question.

The platform (10) provides intelligent product and parts lists that automatically ensure that one entity or record exists on the platform (10) for each distinct product, part or service, regardless of different taxonomies that may exist for the same product, part, or service.

The platform (10) includes a logger that is operable to track the interaction of users with a particular maintenance document, which may include viewing, downloading, forwarding, rating, or recommending a maintenance document. This information may be logged by the logger to a maintenance profile associated with the maintenance document. The analytics engine may include one or more scoring mechanisms for associating a score from time to time with a particular maintenance document.

The incentive platform may include incentives for users to create high quality maintenance documents, based on output from the scoring mechanisms.

The platform may include a suggestion engine. The suggestion engine may be part of or linked to the analytics engine. The suggestion engine has been developed to analyze information available on the platform (10) for the platform client, for example, their appliance list and optionally their maintenance list or inventory levels of parts. The suggestion engine can actively suggest maintenance activities for example a different maintenance schedule that based on best practices determined across a relevant community associated with the platform (10) appears to provide better results.

For example, the suggestion engine may be used as a mechanism to make up for gaps of knowledge that may exist in a particular platform client's maintenance team, by leveraging the collective know-how of a community by operation of the platform (10). The suggestion engine may also be utilized as a mechanism to promote preventative maintenance as opposed to responsive maintenance, and also better allocation of resources for a better overall result to the enterprise.

The suggestion engine may also be utilized to suggest alternative products for example a new machine to replace an existing machine or a replacement part or a service. The suggestion engine may be used for example by manufacturers or distributors given access to this tool by the operator of the platform (10) to up sell their customers through the platform (10). The suggestion engine may (A) automatically access deep information regarding for example the appliance that a particular customers uses, how this appliance is used, what other appliances the consumer may use, and (B) use operations embodied in the analytics engine to generate automatically intelligence concerning a consumer and their possible appliance, product or service needs, or are accumulated based on costly sales efforts directed to accessing intelligence regarding a customer's operations. The platform may provide a scalable tool that provides intelligent suggestions to for example manufacturers or distributors regarding specific requirements of a customer or potential customer. These suggestions may be used to for example direct sales/marketing efforts more efficiently, and improve return on investment from these efforts. Customers or potential customers receive sales/marketing related communications that are relevant to them and timely, and therefore a much better received than sales/marking communications that are enabled using prior art methods and solutions.

Therefore in another implementation of the present invention, the platform (10) may be operable to generate leads, and provide these for example to a manufacturer or a distributor. In one possible implementation, distributors may pay for these leads. In a particular implementation of the invention, the platform (10) may include for example a transaction infrastructure for processing transactions for example between a platform client and a distributor who is also linked to the platform (10) in regards to the purchase of a part or of a machine. As further explained below, the platform (10) may provide the infrastructure for supporting the deployment of applications for example for ordering parts/products from a particular source. Linking an ecommerce utility for ordering and purchasing parts/products to the platform of the present invention enables a manufacturer or distributor to utilize unique and innovative features, and also decreases the costs associated with development and maintaining such an ecommerce utility.

In addition, the suggestion engine may also be configured to automatically analyze information regarding a platform client available through the platform (10) including for example (i) their use of for example appliances, (ii) the current status of the appliances, and automatically generate one or more recommendations or suggestions regarding appliances, parts, or services that may provide an advantage to the platform (10). For example, the suggestion engine may enable the automated analysis of the operations of a platform client (12) and suggest (i) purchase of a different type of appliance, and/or (ii) operation or maintenance of the appliances in a different manner that enables costs to be lowered, provides better return on investment, improved productivity or some other improvement in results.

In one example of the implementation of the present invention, the platform (10) iteratively collects insights into maintenance of appliances, for example by aggregating the actions taken by different users and resulting outcomes such as improved performance or increases in life cycle of a particular appliance. The platform (10) is configured to track the current life cycle and performance of appliance A being used by platform client X. The platform (10) may access best practices for appliance A, generated by the analytics engine (50), and based on the applicable best practices sends a message to platform client X by operation of the suggestion engine (51) suggesting for example as follows: “Consider changing motor to maintain performance.”

Another advantage is that platform clients can benchmark the performance of their equipment and/or their maintenance personnel based on industry standards that can be established automatically through the platform (10). Information of this nature was not readily available prior to development of the platform (10).

In another aspect of the invention, geo-location information or environmental information may be collected and associated with particular equipment through the data records (46). This information may be utilized to discover insights into equipment performance that may not have been otherwise available such as the impact of environmental conditions such as temperature or humidity on performance. Again, the collection of such information and making it available to the communities enabled by the platform (10) is far more likely to result in useful discoveries than individual analysis.

### Sharing Other Resources

Embodiments described herein may also enable the sharing of other resources apart from information as described above.

Many enterprises or consumers have spare parts that they do not require immediately, and in fact they may never need because they are for a machine that they no longer use. Some have estimated that there are hundreds of billions of dollars in parts inventory that are not required, in North America alone.

The CMMS (60) may incorporate the part sharing features.

A group of platform clients may also collaborate by participating in group buying through the platform (10). In one aspect, the platform includes or may be linked to an electronic Request for Quote (“RFQ”) system (68). The RFQ system may track identical or similar requirements across several platform clients, possibly automatically based on analysis of the platform clients' inventory lists and associated maintenance requirements (as determined by the platform based on observation of community behaviour). Further details regarding a possible RFQ system integrated with a CMMS.

Embodiments described herein may also include a consumer focused bidding system (70). The bidding system (70) may incorporate various features commonly used in bidding systems. The bidding system (70), however, is used for a different purpose and includes new functionality. In one aspect, the bidding system (70) allows consumers to put out maintenance jobs for example for local service providers to bid on. The platform (10) may automatically generate for example a draft bid for modification/approval by a consumer, based on the platform's (10) knowledge of maintenance requirements for an appliance (12), based on the operation of the data harvesting layer (20) describe above. The bidding system (70) may be linked to the social networking platform (16) so as to enable the consumer to leverage their social network to look for recommendations of service technicians or service businesses. This can also be done by manufacturers soliciting service businesses to carry out work for customers.

### Incentive System

The platform (10) may also include an incentive platform (72) for enabling a variety of incentives to encourage desired behaviours from different users of the platform, and on the part of different stakeholders. For example, a manufacturer may encourage consumers who act as advocates for their products. Manufacturers may also choose to reward consumers who attend to maintenance requirements diligently, or who share information about how to optimize performance of their products. Service businesses or distributors may also want to encourage these behaviours. Manufacturers may want to use the platform (10) to track and reward excellent service being provided by service businesses including for example independent service technicians operating locally. Incentives may include for example loyalty points or badges.

The incentive platform (72) may also incorporate various gamification processes for encouraging users to share information or resources.

In one aspect of a possible implementation, consumers may receive discounts on their maintenance charges. For example consumers who have a track record of keeping their service appointments may receive a discount after a certain period of time.

The platform (10) connects consumers to service businesses through social networks that are informed by the extraction of information from appliances, and this enables a number of different and innovative processes and functions. Various incentive programs may be designed and implemented.

The platform (10) may include a campaign manager (not shown) that may be used by for example service businesses who are clients of the platform (10) and wish to design, implement, and test programs for promoting desired behaviours or actions on the part of consumers for example. Various types of campaign programs are possible.

The platform (10) including the incentive system (not shown) for example permits unique and innovative collaborations between different stakeholders, providing significant advantages to various groups of users. For example, manufacturers may be interested in consumers who have bought a particular product, in a particular geographic area, at a particular time to provide certain information, by filling out an online consumer survey for example. This type of information is often of interest for example to manufacturers however quite costly to obtain because of low response rates. The platform (10) however provides an environment where manufacturers may organize various incentives such as coupons, reductions on service calls and so on to reward particular users, for example users who may be advocates of their products.

Various incentive programs are possible.

### Analytics

In one aspect, the platform (10) includes an analytics engine (76) operable to analyze information made available to the platform (10) and automatically generate a variety of metrics such as for example benchmarks for equipment maintenance, consumer satisfaction with maintenance services, or service personnel performance.

For example the analytics engine (76) can:

(A) Harvest aggregated data (such as machine run time data) to drive analytics for decision support and intelligent maintenance;
(B) Optimize maintenance activities for example based on maximizing production or minimizing cost;
(C) Personalize user experience in part to improve compliance with best practice based maintenance parameters;
(D) Identify synergies between platform clients and creating connections between them, including for sharing information and resources;
(E) Analyze information to identify best practices, including as it relates to consumer satisfaction and optimal maintenance actions; (F) Predict and intelligently recommend the proper maintenance schedules, tasks, and lists to users (such as service businesses and their personnel); and
(G) Make recommendations on appropriate modifications to an appliance and/or recommend the use of supplemental or replacement parts based on user defined criteria such as the desire to improve performance, reduce energy consumption, lower operating costs, enhance service life, etc. Such recommendations would result from analyzing aggregated data harvested by the CMMS.

The analytics engine (76) may implement various analytics applications and/or analytical processes.

The analytics engine (76) is operable to provide insights that provide a first line data indicator of trends in appliance use and maintenance that are currently not available, or only are available based on collection of survey responses which is known to be costly to obtain and based on low participation the results may not be representative of trends.

The analytics engine (76) provides business intelligence that can be segmented by local, regional, national and internationally. The analytics engine (76) is operable to generate data to suggest required or recommend maintenance actions.

### Dashboard

The web presentment utility (58) is operable to present a dashboard that enables platform client users to access the various platform features. The dashboard may be implemented for example to enable service businesses to: (A) manage and improve maintenance operations, (B) manage schedule of service personnel, (C) manage communications with consumers who are clients of the service business, (D) target other consumers to become their clients, (E) manage loyalty processes for their clients.

### Consumer Layer

In another aspect of the invention, the platform (10) includes a consumer layer.

There exists a need for one or more tools that enable consumers to manage (A) their various information related to appliances, and (B) their communications with service businesses.

In one implementation, the platform (10) includes a consumer utility (82), which may be implemented as a set of utilities. For example consumer utility (82) may enable a consumer define a series of web pages (or “consumer area” (84)) that may be linked to the server computer program (52) and to the database (53), but may be accessible to the consumer only. These web pages may enable the consumer to manage their information and maintenance activities, and may link to other resources and services as well.

For example, the consumer area (84) may enable a consumer to: (A) easily register their product, appliance or other resource with a service program; (B) registration may automatically create a file accessible from the consumer area (84) that contains information such as manuals, how to guides, a particulars of a maintenance schedule, suggestions of social media groups related to the product and so on. In one implementation, the platform (10) is implemented across different manufacturers and service businesses thereby enabling consumers to use the platform (10) as a single location to store manuals and manage the various maintenance activities which can be quite time consuming and cumbersome. The data pertaining to the appliance and consumer may be stored in a profile.

Storing and accessing paper manuals or warranty certificates is inconvenient, and these documents take up valuable storage space. The platform (10) finally provides a mechanism to store and access this information. In a particular aspect, access can also be delegated to other family members or for example to a personal assistant or contractor who requires the information, or to whom maintenance actions may be delegated.

The platform (10) in one aspect may provide a unified portal for managing all of the suppliers or service businesses with whom a household or business has dealings.

If such a multi-manufacturer platform is provided, with tools for consumers to manage their information related to appliance and associated maintenance activities, this compelling and useful functionality will motivate consumers to use the platform (10) which in turn provides benefits to service businesses and manufacturers alike, in providing a platform (10) that enables them to engage efficiently with consumers and in a way that allows them to build their brand effectively.

In one implementation, the consumer area (84) may include for example an aggregated calendar that shows the various scheduled maintenance activities, across their various appliances. The consumer also benefits from the use of a single online portal to manage communications with their various service businesses and the various service technicians. This helps avoid the clutter and time normally associated with co-ordinating these activities.

A skilled reader will appreciate that the consumer utility (82) may be implemented as or may connect to a mobile application or mobile web app that enables consumers to access their information and manage their maintenance interactions from their mobile device for example. For example, consumers may use a mobile application component of the consumer utility (82) to manage their appointments related to the maintenance of their appliances.

Many other implementations are possible.

The consumer area (84) also provides valuable real estate for targeting messaging toward selected consumers or groups of consumers. Aggregated view of a consumer's appliances for example, or their maintenance activities, or social interaction through the platform (10) may enable the analytics engine (76) to determine other products or services that may be of interest to the consumers or groups of consumers. In other words, the platform (10) provides abilities to target to consumer in ways that were previously not possible using shared and collective data regarding appliances and maintenance.

The consumer area may also provide access to information regarding maintenance of a consumer's appliances, and also information regarding other products from a manufacturer.

### Social Networking Environment

The social networking environment should be understood to include social networking aspects incorporated into a resource management or maintenance management related platform. The social media interactions relate to community interactions around sharing of maintenance information and resources through a web enabled platform.

Certain possible attributes of the social networking platform (16) are described herein. The web presentment utility (58) is operable to generate a series of web pages, as directed by the social networking platform (16) so as to define a series of user interactions and/or workflows, including social interactions that define the social networking environment described herein.

Embodiments described herein may enable the connection of various stakeholders as previously explained in order to improve communications between them, and streamline access to information, expertise, local knowledge, maintenance knowledge, equipment knowledge, or other facts that, when brought together within a social networking platform that enables cost effective, familiar and engaging social interactions, can provide and create synergistic value around important resource management objectives having a shared benefit across two or more platform clients.

The social networking platform (16) may be used to implement a variety of social media interactions that promote objectives of the platform (10). For example, social media interactions between users may be initiated so as to (A) identify users engaged in similar activities, such as maintaining similar equipment, or indicating a similar knowledge base, (B) suggest that such users “friend” one another through the social networking platform (16), and (C) enable communications and social media interactions between “friended” users.

The system and method of the embodiments described herein is operable to distribute knowledge in order to improve maintenance related outcomes to consumers. The social networking platform (16) may automate certain aspects of the training of service technicians. The social networking platform (16) also provides a novel and innovative means for enabling service technicians to market their services in an effective manner.

The social networking platform (16) may be generally implemented using one or more application servers. For example, the social networking platform (16) system that may include an application server and graph servers. The application server manages a member database, a relationship database, and a search database. The application server may also contain a matching engine to enable the suggestion of friend combinations based on a series of criteria. Friend suggestions may require acceptance, after which they are added to relevant social graphs managed using the graph server. The matching engine may suggest friend matches based on criteria such as similarity of industry, but filtering matches between competing organization established for example based on user defined competitors lists. The matching engine may include various functions or features for matching individuals based on a variety of criteria including for example demographic attributes, personality traits, and also factors related to the enterprise objectives. For example the matching engine may be used to match friends within groups defined by the social networking environment based on similarity or dissimilarity (depending on for example campaign objectives) of experience, training, maintenance certificates and so on. Matching may also be based on attributes associated with for example the retail stores in which users may operate. For example, users may be matched with users who work at similar businesses or maintain similar equipment. The purpose of matching user 1 with user 2 may be to enable user 2 to share for example maintenance action tips with user 1 in an engaging atmosphere that both user 1 and user 2 are familiar. The social interactions enabled by the social networking platform (16) provide an informal setting for user 1 and user 2 to socialize and in the process share tips regarding maintenance.

The social networking platform (16) may also be configured to implement a number of community interactions, and also activities initiated by the operator of the platform (10) such as crowd sourcing of activities that add value to the platform (10). In one example, the social networking platform (16) may be used to create and promote projects for example related to collaborative productive design in order to improve engagement of consumers and improve product design. In one possible implementation of the invention, the platform (10) includes a managed crowd sourcing system that enables the operator or one or more of the platform clients (12) to design a campaign to provide incentives to other users to translate content. For example, a manufacturer or a distributor may provide incentives through the platform (16) to platform clients (12) or their personnel to create translations of technical information related to their products. Translations may be distributed through the platform (10) based on a number of different monetization models or incentive models that may be supported by the platform (10).

### Workflow

Various workflows are described in this disclosure. One workflow and computer implemented method of the present invention includes:

(A) a plurality of consumers accessing the platform define a list of appliances;
(B) The operator of the platform (10) optionally providing hardware and/or software that enables consumers to harvest and provide to the platform (10) maintenance information; and
(C) The platform logging the maintenance information, and based on this information the platform enabling one or more intelligent features for booking, managing and/or completing service calls related to the appliances.

Referring now to FIG. 5, there is shown a method (200) for computerized maintenance management of consumer resources. The method may integrate a CMMS 60 and social networking platform 16 to leverage collective data for maintenance of consumer resources.

At 202, platform (10) collects, using the at least one data harvesting unit (24), data regarding a plurality of consumer resources (12) and maintenance services for the plurality of consumer resources (12). Each consumer resource (12) is associated with an identifier so that the information may be correlated, linked to, and aggregated with data for similar or the same appliances (12). This may enable platform (10) to leverage power of collective data.

At 204, the platform (10) processes the collected data to generate maintenance information (14).

For each of one or more of the plurality of consumer resources, at 206, platform (10) determines the current status of the consumer resource using the collected data and maintenance information. The current status may relate to usage, performance, last maintenance servicing, and so on. The current status may be used to retrieve data for appliances (12) with similar status.

At 208, platform (10) determines one or more relevant maintenance profiles for the consumer resources using the identifier for the consumer resource. The maintenance profiles may be a set of rules for maintenance workflow, user guides, manuals, data provided by service providers or manufacturers, and so on. The maintenance profile may link current status with known issues to recommend a maintenance action. The maintenance profile may link current status with issues derived by processing and analyzing data for similar appliances, for example.

At 210, platform (10) compares the current status to the one or more relevant maintenance profiles. The maintenance profiles may be indexed by appliance or resource identifiers, and the current status may be associated with an appliance for the same identifier. Accordingly, the identifier provides a mechanism to link an appliance status to the profile.

At 212, based on the one or more relevant maintenance profiles, platform (10) triggers one or more maintenance action and/or product or service requirements related processes. Example processes are described herein and may include at least one of booking of a service call, ordering of a part, remote diagnostic, performing a remote update, generating an alert, and transmitting a notification.

### Example in Operation

The operation may be illustrated in a use case.

‘Smart’ consumer appliances are becoming commonplace in the home. Today, appliances are full of sensors to self-monitor usage and power consumption, and can adaptively adjust in response to existing conditions, for example, when electricity spot prices are high, then the appliance will delay starting, or reduce the cycle time. Smart appliances connect wirelessly to the Internet to obtain and send information.

As an extension to the smart appliance, a Manufacturer A, now embeds into the existing on-board computer system firmware that implements the data harvesting features described above, and optionally features of the CMMS (60). In one implementation, the data harvesting layer (20) automatically monitors the appliance health and usage history of the device, effectively making the appliance ‘self-aware’ (e.g. collects data at 202). Manufacturer A may make a range of smart consumer appliances from dishwashers to fridges to washers and dryers, and may install the CMMS (60) firmware on all of these.

For example, when a consumer buys and installs the smart appliance from Manufacturer A, in this case the CleanPro Dishwasher model, the CMMS (60) automatically monitors its use, such as, but not limited to, number of cycles run, runtime, conditions used (short run, extra duty load, etc), etc. This information is collected and stored at 202 in a data store linked to the data harvesting unit (24) and then may be sent wirelessly over the Internet through a wireless router (36).

The data harvesting unit (24) may connect via the Internet to the central server computer (34) using the consumer's WIFI router (36). The central server computer (34) may be implemented as a cloud-based Central Maintenance Platform (“CMP”) where the maintenance information is collected and curated.

In one aspect, at 202, the CMP collects data from smart appliances of different makes and models belonging to consumers from all over the world.

Moreover, the CMP may monitor and link repair data to the appliance usage record when an appliance has been repaired in the field by a service technician, for example. This may be additional data collected at 202. The data collected may also relate to status information for the appliances.

Over time, the CMP may build a significant database of usage and repair history by repeating step 202 and at 204 may process the collected data to begin to spot trends and important signals from the data (an example of maintenance information) that can be acted on in a variety of beneficial ways.

In one example of the use of the analytics engine (76), the CMP determines that the drive belt of the CleanPro dishwasher is being replaced in the field more than twice as often on average over a 5 year time period in the US Southwest region, consisting of Arizona, New Mexico and Western Texas. Furthermore, through semantically analyzing the data, the CMP additionally determines that when the dishwasher's “pots and pans” cycle is used at least 5 times a month AND the ‘high temperature’ function is used 80% of the time the appliance is run, the belts in this region are failing more often than normal. Accordingly the processing referred to at 204 may be implemented by one or more components of platform (10).

The CMP also decides that for dishwashers that are less than 3 years old and still under warranty (example of status information and collected data), it is ultimately cheaper to replace the belt versus waiting for the belt to fail and risking further damage to the adjacent motor assembly. This will avoid future high repair bills for the customer, thus leading to happier customers and strengthening brand loyalty based on high reliability of the appliances over the long term.

The CMP then checks its database for maintenance profiles of appliances that are typically run under these conditions by customers in the US Southwest and builds a list of users at increased risk of a drive belt failure. This list is in chronological order, with users with older belts closer to the calculated ‘failure time’ given priority for service.

The CMP communicates this list to numerous stakeholders and automatically initiates several actions at once. The list may be example of maintenance actions or product requirements.

At the manufacturer, the list is used to understand and improve on designs that can be more robust and even ‘geo-specific’ in the types of parts used. This greatly reduces warranty and repair costs and liabilities.

The CMP now communicates this list to local service technicians who are capable of carrying out an intended repair (a further example of a maintenance action). Furthermore, the CMP checks the inventory of the service providers to determine if the necessary drive belt for the ProClean model is available (another example of a maintenance action).

Since the appliance is still under warranty, the cost of the service will be picked up by the manufacturer. However, the manufacturer has set its preferences in the CMP for it to always put out a competitive bid process to multiple service technicians. This may be considered by platform with generate an a recommended action. So the CMP compiles an RFP, detailing the work needed and the recommended procedures and tasks based on best practices, and sends out via electronic communication (for example, email, TWITTER™, FACEBOOK™, text messaging, and so on) to appropriate service providers who have met all prerequisite conditions. Maintenance profiles may include data regarding the recommended procedures and tasks based on best practices for a variety of appliances, manufacturers, and so on. The maintenance profiles may also be generated by leverage shared collective data regarding appliances to derive best practices based on usage history, trends, and so on.

The CMP receives quotes back, and automatically chooses the lowest bid, since this is the preference set by the manufacturer who is paying for the cost. The CMP now works to schedule a service visit.

First the CMP may communicate with the customer via a predetermined method such as email, TWITTER™, FACEBOOK™, text messaging, etc. (as determined in the consumer's preferences) and informs the consumer that a service visit is necessary to keep the appliance in top running condition and avoid undesirable downtime, in accordance with experiences of other customers in the region. The consumer responds back with times he/she is available to meet the service provider at the house.

Now the CMP informs the chosen service technician of available times and a visit is scheduled. The service technician has all the details of the required repair and, importantly, which parts are needed so that he arrives at the house with the part in hand. This obviates the need for an expensive 2nd house call. The CMP confirms the scheduled visit time with the consumer.

However, the CMP knows that this service provider does not have the required part on hand and one will need to be ordered. The CMP automatically searches for the part in the inventories of service providers throughout its network, and identifies a matching part located in both Jacksonville, Fla. and Los Angeles, Calif. The CMP automatically sends requests to these identified service technicians to procure the part and receives bids back. This may be provided at 212 as part of the provision of recommended actions.

However, the bid prices are not accepted by the manufacturer (again, limits are set in its preferences). In response, the CMP prepares a Request for Quotation (RFQ) to a nationwide parts distributor for the needed belt. However, as the distributor provides steep volume discounts, the CMP checks for the total number of belts that will be needed over a given forecast period of 2 years, which is determined to be 545 for the US Southwest region. The CMP sends an RFQ for 545 driver belts and gets the discount pricing. The parts are then shipped to the regional warehouse that can then be easily distributed to the local technicians. The part is shipped to the approved service provider in time before the scheduled call.

Prior to the house call, the CMP also informs the service provider of the other appliances the consumer has, and through records in the CMP database, provides the general predicted ‘health’ of the appliances and recommendations on which ones will require preventative service in the near future. Now the service provider can, in addition to completing the primary repair mission of the visit, advise the consumer on site of other upcoming work that should be carried out, especially for appliances that are ‘out of warranty’, and that repairing them now will save the consumer much more money in the future. Thus the service provider becomes a sales person too.

The service provider arrives at the home and begins to carry out the required preventative repair on the drive belt. However, he notices that there is some unexpected wear on the motor's gear box caused by the belt. This may be provided as additional data at 202. Being unsure why this is so, or how it might be repaired, the service provider uses his tablet, installed with his own version of the CMMS (60), and through the communication tools plugs into the CMP, which then reaches out to other expert service providers throughout the network. Further data may be collected at 202. One service provider in Montreal who is online at that moment sees the question and calls the service provider within 2 minutes to discuss the problem, why it is occurring, and most importantly what to do to repair and prevent the problem from recurring. The service provider in Montreal may receive an incentive in the form of a badge, credits, or other predetermined incentive or compensation. The service provider finishes the repair and enters all the repair notes (as collected data at 202), including parts used, into the tablet version of his CMMS (60). This record is synced with the CMP at 202 and linked with the customer record and the appliance profile in question. The status information for the appliance may also be updated.

Once the repair is complete on the dishwasher, the service provider then moves on to advise the consumer of the recommended preventative maintenance requirements on his washing machine, and shows the consumer statistics provided by the CMP for his machine and his neighbourhood. The consumer decides to sign up to a top-tier Platinum extended warranty package. This may be collected as data at 202.

Once the visit is complete, the CMP compiles the records and ranks the performance of the technician compared to average performance levels of his peers. This information may be stored in a maintenance profile for subsequent reference with generating actions. This information is used by the service provider to understand where improvements can be made in his service techniques (and thus save costs). Moreover, Manufacturer A can decide if they want to continue working with the service provider or not depending on historical performance and costs to serve.

In another possible implementation, the platform may be used to improve service for example when there is an unscheduled machine failure, for example, when a dishwasher that breaks during the evening cycle. The platform may sense this and self-diagnose the problem and required parts. The platform may check the warranty status and find an appropriate service provider who has the necessary inventory to fix the problem. The platform sends out a request notification at 212 using the selected communication method in order to schedule the repair. This may provide an affordable, fast, highly rated maintenance solution (based on consumer ratings or manufacturer preferences).

### General

It will be appreciated that any module or component exemplified herein that executes instructions may include or otherwise have access to computer readable media such as storage media, computer storage media, or data storage devices (removable and/or non-removable) such as, for example, magnetic disks, optical disks, tape, and other forms of computer readable media. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD), blue-ray disks, or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 10, tracking module 30, object tracking application 34, etc., or accessible or connectable thereto. Any application or module herein described may be implemented using computer readable/executable instructions that may be stored or otherwise held by such computer readable media. FIG. 3 shows a possible computer system for use by a user to access functionality of platform, such as a consumer, service provider, manufacturer, administrator, and so on.

A skilled reader will recognize that other example various extensions to the features and functions described are possible such as extending the automated or intelligent features of the platform.

It will also be appreciated that the block configurations, screen shots, and flow charts provided herein are for illustrative purposes only and various modifications thereof are applicable within the principles discussed herein.

Although the above principles have been described with reference to certain specific embodiments, various modifications thereof will be apparent to those skilled in the art without departing from the scope of the invention and the claims appended hereto. Other modifications are therefore possible.

### Advantages

Various advantages of the present invention have already been mentioned above. Further advantages of the invention are described below.

Embodiments described herein may provide one or more of the following advantages: a unique and innovative CMMS offering; a unique and innovative consumer facing CMMS; a CMMS platform that integrates maintenance services, and improves communications and efficiency of service engagements; a CMMS platform that integrates group buying features for savings made available across platform client groups; a resource management platform that integrates a social networking platform in order to facilitate information and resource sharing thus providing significant added value to manufacturers, service businesses, and consumers; a robust and scalable, web enabled platform that in a multi-tenant architecture allows various manufacturers and service businesses to manage their maintenance actions and associated activities; a unique and innovative business model that provides free or low cost access to a valuable platform, delivering savings to consumers, manufacturers and service businesses, and delivering a transaction based commission to the operator of the platform; a web based platform that is accessible from many different devices, including smart phones and tablets, and provides easy access to maintenance related information and activities through a single, intuitive interface, thus replacing costly and inconvenient paper processes and/or multiple technologies used for the same functions; a platform that enables platform clients to share information, on their terms, in a way that provides benefit back to those sharing; a platform that enables crowd-sourcing of accumulation of valuable intelligence regarding maintenance of appliances; a platform that enables platform clients to create efficiencies and cost savings; and a CMMS that integrates with a robust transaction platform thereby providing access to rich transactional data for shared benefit, and single point platform for tracking maintenance activities and managing related transactions; a platform that enables platform clients to align around the resolution of technical and supply-chain problem and the improvement of workflow; a platform that enables platform clients to improve their business operations and increase business productivity; a CMMS that helps avoid machine failure, machine downtime, lost productivity, and significant costs associated with additional parts/services requirements; a platform that uses the platform generated crowd to have a greater group impact on suppliers by encouraging improvements in product designs, manufacturing quality, service packages and so on; a platform that enables for the first time mass collaboration in connection with equipment maintenance using a social internet based approach; a platform that enables value to be unlocked from inventories that would otherwise be obsolete; a platform that may provide a single portal enabling consumers to manage their appliance and maintenance related information and communications; a platform that may enable manufacturers and/or service businesses to improve their relations with customers/consumers in an efficient way; a platform that may enable the life cycle of products to be lengthened and performance of products to be improved based on more efficient management of maintenance service delivery; a new model for “social-networking-for-business”; a platform that may allow for the first time auto-populating a user's CMMS data records and databases, auto-generating records (such as asset lists of a facility, parts used with assets, recommended maintenance schedules and procedures, etc), auto-completion of partial records, for easy on-boarding and ongoing use of the CMMS; a platform that may predict and intelligently recommends the proper maintenance schedules, tasks and lists to platform clients who desire such information based on equipment usage or queries asked, and offer recommendations to optimize their processes, including procurement of parts, equipment, etc or offering specialized data intelligence.

1. A computerized maintenance management system (CMMS) is provided that is connected to the Internet and enables a plurality of network connected devices to access a novel and innovative maintenance service management platform, the CMMS comprising:
at least one data harvesting unit provided by at least one processor and at least one memory storing executable instructions to configure the at least one data harvesting unit to:
collect data regarding a plurality of consumer resources and maintenance services for the plurality of consumer resources, wherein each of the plurality of consumer resources is associated with an identifier, and
process the collected data to generate maintenance information;
one or more computers linked to a server application, the computers and server application providing one or more utilities to:
for each of one or more of the plurality of consumer resources:
determine the current status of the consumer resource using the collected data and maintenance information;
determine one or more relevant maintenance profiles for the consumer resources using the identifier for the consumer resource;
compare the current status to the one or more relevant maintenance profiles; and
based on the one or more relevant maintenance profiles trigger one or more maintenance action and/or product or service requirements related processes, including at least one of booking of a service call, ordering of a part, remote diagnostic, remote update, generating an alert, and transmitting a notification.

2. The computer system of claim 1, further comprising:
one or more connected consumer resources of the plurality of consumer resources, wherein the connected consumer resources are coupled to the at least one data harvesting unit for the automatic provision of the collected data.

3. The computer system of claim 1, further comprising:
a plurality of computer terminals linked to a computer network, each computer terminal associated with an individual, wherein each individual is associated with one or more of the plurality of consumer resources; and
wherein the one or more computers are made available to users of a plurality of clients using the computer terminals; and
wherein the CMMS (i) tracks activities of users across at least two clients in connection with the management of resources, (ii) extracts insights from such activities, and optionally (iii) enables users to upload the data regarding the plurality of consumer resources and the maintenance services, and extracts from such collected data and the maintenance information an information set;
and wherein the CMMS analyses the information set and generates automatically the maintenance action and/or product or service requirements related processes, and communicates maintenance action and/or product or service requirements related processes to one or more clients for whom it is determined that the suggestions are relevant.

4. The computer system of claim 1, wherein the maintenance action and/or product or service requirements related processes include preventative maintenance actions.

5. The computer system of claim 1, wherein the one or more computers monitors the performance of a set of consumer resources associated with varying maintenance actions to determine the current statuses, and extracts best practice information based on the consumer resources that perform the best, and uses these best practices to generate the maintenance action and/or product or service requirements related processes.

6. The system of claim 5, wherein the best practice information includes a suggested maintenance schedule for a consumer resource.

7. The computer system of claim 1, further comprising: one or more data filters for filtering confidential information, sensitive information, or information that a client elects not to share from the maintenance action and/or product or service requirements related processes.

8. The computer system of claim 1, further comprising one or more inventory management tools to provide an inventory of equipment resources regarding the plurality of consumer resources, wherein the utilities are further configured to automatically order an equipment resource from a supplier based on the maintenance action and/or product or service requirements related processes.

9. The computer system of claim 1, further comprising: a social networking platform that enables clients to selectively share maintenance related information, wherein the maintenance related information is correlate for a particular consumer resource using the identifier for the particular consumer resource.

10. The computer system of claim 9, wherein the social networking platform enables clients to aggregate product or service requirements for the plurality of consumer resources in order to share costs.

11. The computer system of claim 1, wherein the social networking platform enables clients to permit inventory information regarding the plurality of consumer resources to be accessible, or accessible in part, by one or more other clients selected by them, in order to share inventory, including equipment resources or parts inventory for the plurality of consumer resources.

12. The computer system of claim 1, the one or more utilities allows clients to search for required service providers or parts from networked clients based on service provider or part parameters and geographic parameters.

13. The system of claim 1, wherein the CMMS includes or connects to a semantic analyzer for determining that two or more information sets relate to a similar resource or to the same resource.

14. A method for computerized maintenance management of consumer resources, the method comprising
providing at least one data harvesting unit by at least one processor;
collecting, using the at least one data harvesting unit, data regarding a plurality of consumer resources and maintenance services for the plurality of consumer resources, wherein each of the plurality of consumer resources is associated with an identifier, and processing, using the at least one data harvesting unit, the collected data to generate maintenance information;
using one or more computers linked to a server application for providing one or more utilities, for each of one or more of the plurality of consumer resources:
determining the current status of the consumer resource using the collected data and maintenance information;
determining one or more relevant maintenance profiles for the consumer resources using the identifier for the consumer resource;
comparing the current status to the one or more relevant maintenance profiles; and
based on the one or more relevant maintenance profiles triggering one or more maintenance action and/or product or service requirements related processes, including at least one of booking of a service call, ordering of a part, remote diagnostic, performing a remote update, generating an alert, and transmitting a notification.

15. The method of claim 14 further comprising:
linking one or more computer terminals to one or more computers executing a computerized maintenance management system (CMMS), implemented as a computer network service made available to users of a plurality of clients using the computer terminals, wherein each computer terminal is associated with an individual;
two or more clients permitting the CMMS to (i) track activities of users across the participating clients in connection with the management of the plurality of consumer resources, (ii) extract insights from such activities, and optionally (iii) enabling users to upload information or documents related to the plurality of consumer resources, thereby extracting an information set;
executing an analytics and suggestion routine, the analytics and suggestion routine analyzing the information set and generating automatically the maintenance action and/or product or service requirements related processes for clients; and
at least one client receiving the maintenance action and/or product or service requirements related processes at one or more computer terminals.

16. The method of claim 14 further comprising: aggregating maintenance data received via social networking platform to populate one or more of the maintenance profiles.

17. The method of claim 14 further comprising: filtering the maintenance action and/or product or service requirements related processes for relevance to a participating client, and transferring to the participating client relevant suggestions.

18. The method of claim 14 further comprising suggesting preventative maintenance actions.

19. The method of claim 14 further comprising: monitoring performance of the plurality of consumer resources associated with varying maintenance actions, and extracting best practice information based on the resources that perform the best, and using these best practices to generate the maintenance action and/or product or service requirements related processes.

20. The method of claim 14 further comprising filtering confidential information, sensitive information, or information that a client elects not to share, from the maintenance action and/or product or service requirements related processes.
